(19) United States
(12) Patent Application Publication
(10) Pub. No.: US 2026/0186670 A1
(43) Pub. Date: Jul. 2, 2026

(54) STORAGE SYSTEM AND DATA PROTECTION METHOD THEREFOR

(71) Applicant: Hitachi Vantara, Ltd., Tokyo (JP)

(72) Inventors: Masahiro TSURUYA, Tokyo (JP); Takashi NAGAO, Tokyo (JP); Yoshihiro YOSHII, Tokyo (JP)

(73) Assignee: Hitachi Vantara, Ltd., Tokyo (JP)

(21) Appl. No.: 19/317,240

(22) Filed: Sep. 3, 2025

(30) Foreign Application Priority Data
Dec. 27, 2024 (JP) 2024-232284

(51) Int. Cl. G06F 3/06

(52) U.S. Cl. CPC G06F 3/0619; G06F 3/0625; G06F 3/0659; G06F 3/067

(57) ABSTRACT

In order to solve the above problem, when the power saving mode is applied, the journal data is recorded in the log buffer in a narrower range than in a normal mode. Then, when a controller failure occurs at the time of applying the power saving mode, the controller that has been stopped is restarted, and at that time, data is read from the log buffer in the narrow range and restoration processing is performed. As a result, it is possible to reduce the power consumption of the storage system and shorten the restoration time.

### DESCRIPTION

### BACKGROUND OF THE INVENTION

### 1. Field of the Invention

This invention relates to a storage system and a data protection method, and is suitably applied to, for example, a storage system related to a technology of storing journal data of a log buffer by journaling.

### 2. Description of the Related Art

JP 2014-519061 A discloses a storage system for a specific application. In a general storage system, a history of change of update contents of a file system and metadata (hereinafter also referred to as “control information”) is recorded in a log buffer as journal data in association with data input/output processing with a host computer. The journal data is read from the log buffer in a case where a failure occurs in the system or in a case where data is erroneously deleted, and the journal data is used in restoration processing of rewinding the data to a predetermined time point.

### SUMMARY OF THE INVENTION

However, in not only the storage system disclosed in JP 2014-519061 A but also a general storage system, since a range of a log buffer in which journal data is recorded is wide, a range in which the journal data is read from the log buffer at the time of restoration processing is wide, and for example, the restoration time is long at the time of recovering one controller that has stopped for reducing power consumption.

This invention has been made in view of the above points, and an object of this invention is to propose a storage system capable of shortening a restoration time using journal data even in a case where one controller of a plurality of controllers is stopped in order to reduce power consumption.

In order to solve the above problem, this invention is a storage system including a plurality of controllers that controls data input/output processing between a host computer and a drive, in which one controller of the plurality of controllers performs journaling in association with the data input/output processing, and writes journal data related to the data input/output processing between the host computer and the drive to a log buffer secured over a first range, when another controller of the plurality of controllers satisfies a predetermined transition condition, the one controller starts transition from a normal state to a power saving mode for stopping the another controller, when the another controller is stopped in the power saving mode after transition, the one controller secures the log buffer to be in a second range narrower than the first range, and then performs journaling in association with the data input/output processing between the host computer and the drive, and when the another controller is restarted, the one controller executes restoration processing by using the journal data read from the log buffer secured over the second range.

This invention is a data protection method of a storage system including a plurality of controllers that controls data input/output processing between a host computer and a drive, and includes, by one controller of the plurality of controllers, performing journaling in association with the data input/output processing, and writing journal data related to the data input/output processing between the host computer and the drive to a log buffer secured over a first range, when another controller of the plurality of controllers satisfies a predetermined transition condition, by the one controller, starting transition from a normal state to a power saving mode for stopping the another controller, when the another controller is stopped in the power saving mode after transition, by the one controller, securing the log buffer to be in a second range narrower than the first range, and then performing journaling in association with the data input/output processing between the host computer and the drive, and when the another controller is restarted, by the one controller, executing restoration processing by using the journal data read from the log buffer secured over the second range.

According to this invention, in order to reduce the power consumption, even in a case where one controller of the plurality of controllers is stopped, the restoration time using the journal data can be shortened.

### BRIEF DESCRIPTION OF THE DRAWINGS

FIG. 1 is a system configuration diagram illustrating a configuration example of a storage system according to the present embodiment;

FIG. 2 is a diagram illustrating an outline of a write operation when both controllers are normal;

FIG. 3 is a diagram illustrating an outline of the write operation when one controller of the storage system according to the present embodiment is closed;

FIG. 4 is a state transition diagram illustrating an example of an operation mode in the storage system according to the present embodiment;

FIG. 5 is a diagram illustrating contents of a memory illustrated in FIG. 1;

FIG. 6 is a flowchart illustrating an example of a procedure of write processing in the storage system according to the present embodiment;

FIG. 7 is a flowchart illustrating an example of a procedure of memory protection method switching processing in the storage system according to the present embodiment;

FIG. 8 is a flowchart illustrating an example of a procedure of high I/O performance journal protection switching processing illustrated in FIG. 7;

FIG. 9 is a flowchart illustrating an example of a procedure of a restoration time reduction journal protection switching processing illustrated in FIG. 7;

FIG. 10 is a flowchart illustrating an example of a procedure of inter-controller duplication protection switching processing illustrated in FIG. 7;

FIG. 11 is a flowchart illustrating an example of a procedure of processing after occurrence of a controller failure in a power saving mode; and

FIG. 12 is a flowchart illustrating an example of a procedure of destage acceleration processing when a remaining amount of a log buffer decreases.

### DESCRIPTION OF THE PREFERRED EMBODIMENTS

Hereinafter, the present embodiment of this invention will be described in detail with reference to the drawings.

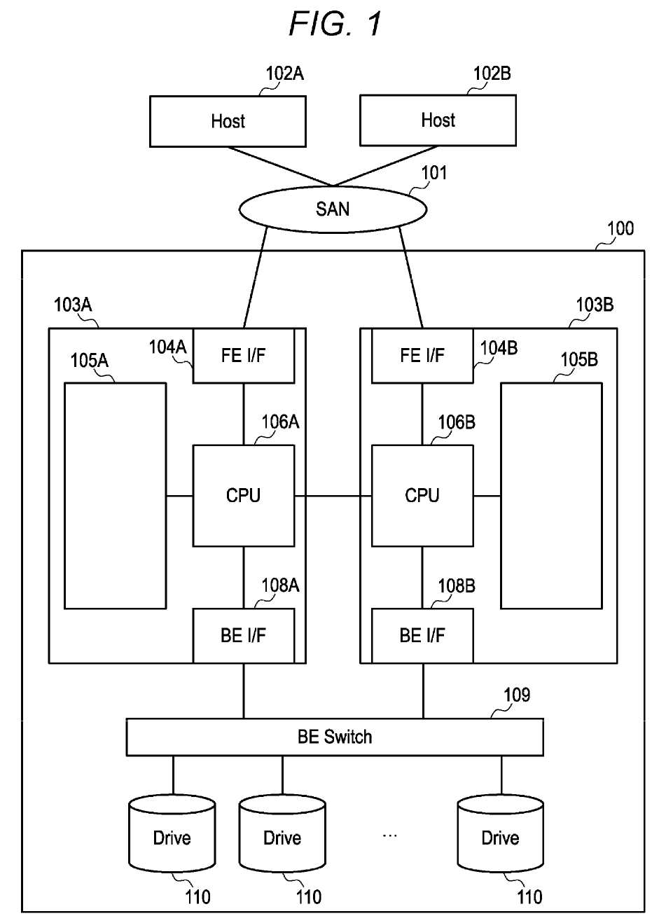

FIG. 1 is a system configuration diagram illustrating a configuration example of a storage system 100 according to the present embodiment. The storage system 100 according to the present embodiment includes a plurality of controllers 103A and 103B and a drive 110 which is a storage device. In the following embodiment, it is mainly described that two controllers 103A and 103B are provided, but three or more controllers may be provided.

The controllers 103A and 103B are devices having a function of providing volumes as data read/write targets to host computers (hereinafter, abbreviated as “hosts”) 102A and 102B. Since the controllers 103 and 103B have substantially similar configurations, the controller 103A will be mainly described in the following description. The controller 103A includes a CPU 106A, a memory 105A, a memory backup drive as an example of a nonvolatile storage medium such as an SSD, a front-end interface (hereinafter also referred to as “FE I/F”) 104A, and a back-end interface (hereinafter also referred to as“ BE I/F”) 108A. The drive 110 is, for example, a solid state drive (SSD) using a flash memory as a storage medium, a hard disk drive (HDD) using a magnetic disk as a storage medium, or the like.

The memory 105A is a storage device in a broad sense, and is, for example, a volatile semiconductor memory such as a DRAM. A log buffer (not illustrated) is secured in a part of the memory 105A. A control information log buffer to be described later is, for example, a nonvolatile storage medium (drive) such as an SSD. The control information log buffer is used to save storage contents of the volatile semiconductor memory when external power is lost. The FE I/F 104A is, for example, a fibre channel host bus adapter (HBA) or a network interface controller (NIC). The BE I/F 108A is, for example, a SAS HBA, a PCI express (hereinafter referred to as “PCIe”) adapter, or a NIC.

The controllers 103A and 103B and the drive 110 are connected by, for example, a switch (BE Switch) 109. The CPU 103A of one controller 106A and the CPU 106B of the other controller 103B are connected by an interconnect such as PCIe. The CPU 106A and the CPU 106B may be connected via, for example, a PCIe switch. The storage system 100 is connected to a storage area network (hereinafter abbreviated as “SAN”) 101 such as Fibre Channel or Ethernet (registered trademark). The host computers 102A and 102B are also connected to the SAN 101. The SAN 101 may include a switch and the like. A plurality of hosts may be connected to the SAN 101.

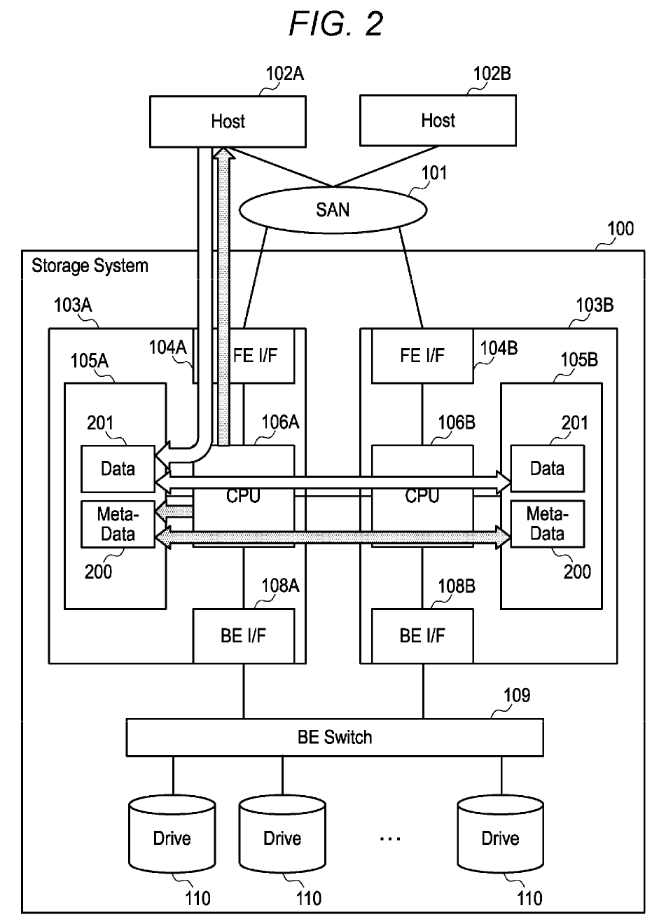

FIG. 2 is a diagram illustrating an outline of a write operation when both controllers are normal. The CPU 106A of the controller 103A receives a write request from the host computer 102A, receives data from the host computer 102A, and writes data 201 to the memory 105A in the controller 103A and the memory 105B of the other controller 103B. The CPU 106A updates control information (Metadata) 200 in the memory 105A. The CPU 106A returns a response of write completion to the host computers 102A and 102B. Although not illustrated in the illustrated example, the CPU 106A writes data written on the memory 105A to the drive 110 at a predetermined timing. In this write operation, the data on the memory 105A and the control information 200 are duplicated between both the controllers 103A and 103B to prepare for a failure of any one controller of the controllers.

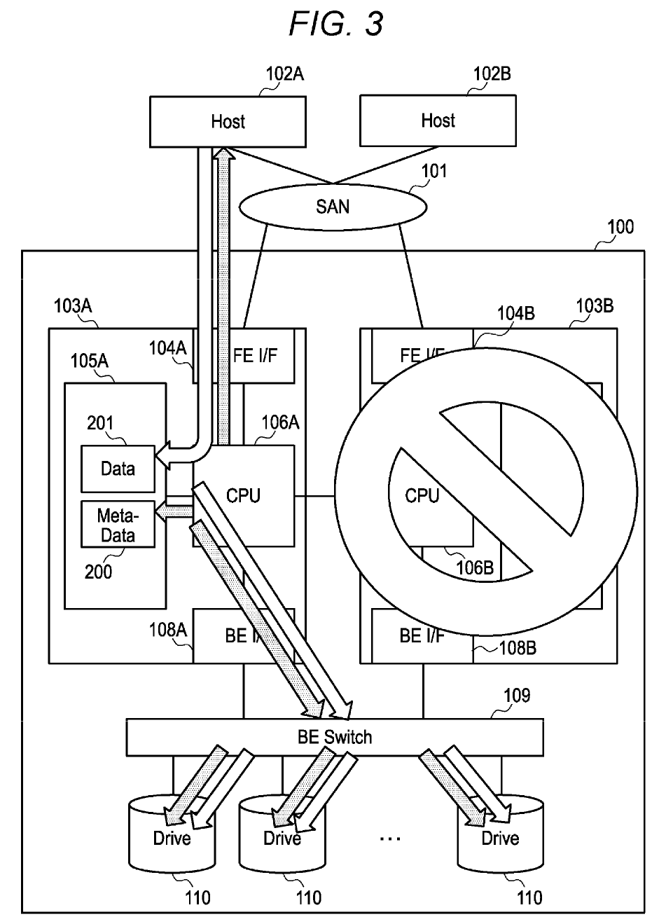

FIG. 3 is a diagram illustrating an outline of the write operation when the controller 103A of the storage system 100 according to the present embodiment is closed. The CPU 106 of the controller 103 according to the present embodiment receives the write request from the host computers 102A and 102B, receives the data 201 from the host computer 102A, and writes the data 201 to the memory 105A in the controller 103A. The CPU 106 updates the control information 200 in the memory. The CPU 106A writes the update content of the data 201 to the control information log buffer as a log, and writes the update content of the control information in the control information log buffer as a log (log saving). The CPU 106A returns a response of write completion to the host computer 102A. Although not illustrated in the illustrated example, the CPU 106A writes data written on the memory 105A to the drive 110 at a predetermined timing (hereinafter also referred to as “destaging”). In the present embodiment, it is described that the logs of the data 201 and the control information 200 are stored in the control information log buffer, but these logs may be recorded, for example, in a user data storage drive (equivalent to the drive 110) or may be recorded in another log storage drive.

In this write operation, the data on the memory 105A and the control information are written as a log to the memory backup drive to prepare for a failure of one of the remaining controllers. If the remaining controller 103B fails, the storage system is temporarily stopped and the system is down, but a data loss can be prevented by repairing and replacing the controller 103B and then recovering the data 201 and the control information 200 on the memory 105A by using the log written in the control information log buffer.

In order to prevent confusion in the following description, a difference between destaging and log saving will be clarified. The destaging is to write dirty data on cache to a final storage area of the user data storage drive which is a final storage medium. In the user data storage drive, data is stored by a storage function provided by a storage system (mainly a controller) with enforced data protection, capacity efficiency, I/O performance, and the like. For example, in the data protection, data is protected by a system such as a redundant array of independent disks (RAID) 6. In this case, parity data is generated in destage processing, and the parity data is also written to the drive 110. Since the data on the memory 105A and the data on the drive 110 coincide with each other (are clean) in the data for which destaging has been completed, there is no problem if the data 201 is lost from the memory 105A.

On the other hand, the log saving refers to temporarily writing the update contents of the data 201 and the control information 200 on the memory 105A to a nonvolatile storage medium (drive) such as a control information log buffer to be described later in preparation for a failure of the controllers 103A and 103B. Even if the data written as a log to the drive 110 (hereinafter referred to as “dirty data”) is lost from the memory 105A, once destaging of the dirty data is completed, there is no problem as described above. Therefore, the log can be deleted from the drive 110 when the destaging is completed.

In a case where the memory backup drive is used for log storage in the present embodiment, an area allocated for both controllers to save the contents of the memory 105A when both controllers are normal may be used as an area for storing a log when one controller 103B is closed. In this way, since it is not necessary to add a drive or a storage capacity in order to store the log, it is advantageous in terms of cost as compared with a case of storing the log in the user data drive or a case of separately mounting the log storage drive.

Incidentally, in a log (cache data log) including update contents of cache data, data written from a host is generally handled in units of blocks such as 512 bytes and 4 Kbytes, and therefore granularity is relatively large. On the other hand, since the control information 200 is in units of Byte, the log (control information log) including the update content of the control information 200 has a relatively small granularity. However, the ratio of the cache data area to the entire memory 105A is relatively large. Therefore, as for the control information log, the entire memory area (base image) in which the control information is stored is periodically written to the drive 110, all logs written before the writing are discarded, and the area where the logs are written is recovered as a free area. This method is called a “base image saving method”.

On the other hand, as for the cache data log, a log that is not the latest among the logs is identified as an unnecessary log, and the unnecessary log is discarded (invalidated). In this way, since a scattered free area is generated in the log buffer, only the valid log is written to another area in a front-crammed way at a predetermined timing to recover a continuous free area. This method is called a garbage collection method. By selectively using these methods, it is possible to reduce the management information for free area management and reduce the overhead for free area recovery while suppressing the capacity consumption for base image saving.

In the present embodiment, as will be described later, the range in which the log is written with respect to the log buffer can be narrowed for each mode. Specifically, in the present embodiment, for example, the size of a storage area in which logs can be written can be controlled such that the log buffer secured in a first range is in a second range narrower than the first range in a specific mode.

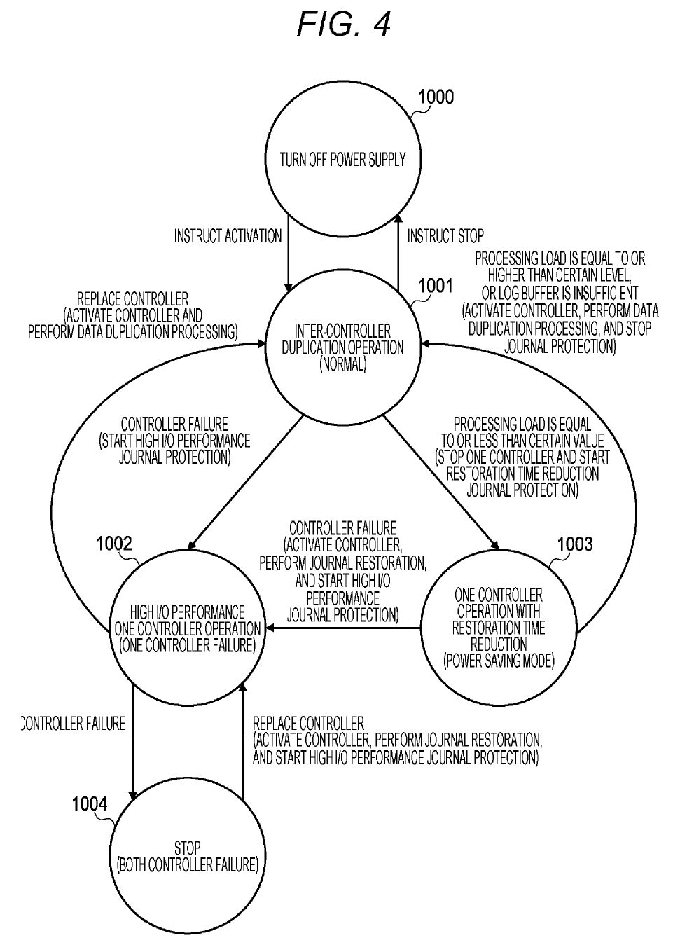

FIG. 4 is a state transition diagram illustrating an example of an operation mode in the storage system 100 according to the present embodiment.

The storage system 100 according to the present embodiment can transition to any of a power-off state 1000, a state 1001 of inter-controller duplication (hereinafter referred to as a “normal state”), a state 1002 of one controller operation of one side with high I/O performance (hereinafter referred to as “one controller failure”), for example, a stop state 1004 due to failure of both controllers (hereinafter referred to as a “stop state”), and a state 1003 in which only one controller operates while shortening a restoration time (hereinafter referred to as a “power saving mode”).

The storage system 100 according to the present embodiment transitions to the normal state 1001 when receiving an activation instruction from a management terminal (not illustrated) in the power-off state 1000. When a controller failure occurs in the normal state 1001, the storage system 100 according to the present embodiment starts high I/O performance journal protection and transitions to the state 1002 of one controller failure. When entering a controller failure state, the storage system 100 according to the present embodiment enters the stop state 1004. Thereafter, the storage system 100 according to the present embodiment performs controller replacement, starts controller activation, journal restoration, and start of the high I/O performance journal protection, and transitions to the state 1002 of one controller failure.

When the controller replacement is performed in the state 1002 of one controller failure, the storage system 100 according to the present embodiment activates the controller, performs data duplication processing of the plurality of controllers 103A and 103B, and transitions to the normal state 1001.

When a processing load becomes equal to or less than a certain value in the normal state 1001, the storage system 100 according to the present embodiment stops one of the controllers, starts journal protection for shortening the restoration time (hereinafter, also referred to as “restoration time reduction journal protection”), and transitions to the power saving mode 1003. The restoration time reduction journal protection means that a range of a log buffer which is a journal area for storing journal data is made narrower than in the normal state as described later.

When a controller failure occurs in the power saving mode 1003, the storage system 100 according to the present embodiment activates the controller, performs the journal restoration, starts the high I/O performance journal protection, and transitions to the state 1002 of one controller failure.

On the other hand, in the power saving mode 1003, when the processing load is equal to or larger than a certain level or the storage capacity of the log buffer is insufficient, the storage system 100 according to the present embodiment starts the controller, performs the data duplication processing, and when the journal protection is stopped, transitions to the normal state 1001.

The storage system 100 according to the present embodiment is a storage system including the plurality of controllers 103A and 103B that controls data input/output processing between the host computers 102A and 102B and the drive 110. One controller 103A of the plurality of controllers 103A and 103B performs journaling in association with the data input/output processing, and writes journal data related to the data input/output processing between the host computers 102A and 102B and the drive 110 in a log buffer secured over the first range (write step). The log buffer constitutes a part of a storage area of a nonvolatile storage medium (not illustrated) as an example. The nonvolatile storage medium has at least a storage capacity over the first range.

When the other controller 103B of the plurality of controllers 103A and 103B satisfies a predetermined transition condition, the one controller 103A starts transition from the normal state to the power saving mode 1003 for stopping the other controller 103B (power saving mode transition step). Note that the term “stop” as used herein includes, for example, being closed and stopping or intentionally stopping.

The one controller 103A then starts transition to the power saving mode 1003 for stopping the other controller 103B on the condition that the processing load of the other controller 103B is lower than in the normal state as the predetermined transition condition.

When the other controller 103B is stopped in the power saving mode 1003 after transition, the one controller 103A secures the log buffer so as to be in the second range narrower than the first range, and then, performs journaling in association with the data input/output processing between the host computers 102A and 102B and the drive 110 (journaling step).

When restarting the other controller 103B, the one controller 103A executes restoration processing by using the journal data read from the log buffer secured over the second range (restoration step).

When a predetermined return condition different from the predetermined transition condition is satisfied, the one controller 103A transitions from the power saving mode to the normal state 1001.

The one controller 103A manages the log buffer by dividing the log buffer into a plurality of unit log buffers.

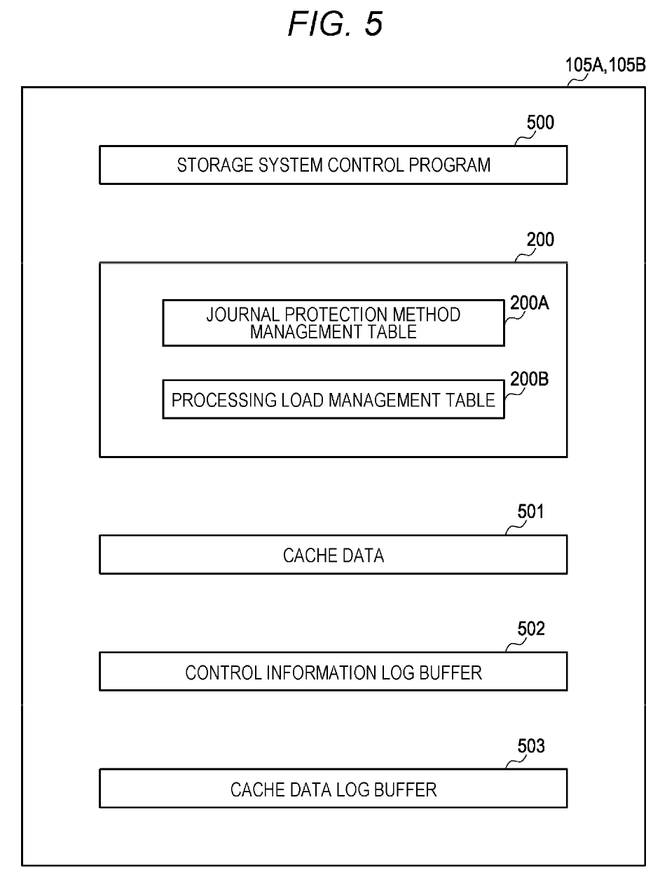

FIG. 5 is a diagram illustrating contents of the memory 105A illustrated in FIG. 1. Note that the contents of the memory 105B, which are the same as the contents of the memory 105A, will not be described.

The memory 105A includes a storage control program 500, control information 200, cache data 201, a control information log buffer 502, and a cache data log buffer 503. The control information 200 includes a journal protection method management table 200A and a processing load management table 200B.

The storage control program 500 is a program for controlling the storage system, and is executed by the CPU 106A. Each processing such as write processing to be described later is included in the contents of the storage control program.

The control information 200 is data used by the storage control program 500 to control execution of a program. The control information 200 includes, for example, cache control information including a correspondence relationship between an address of cache data and a logical address (LBA) in a volume, a state (dirty/clean) of cache data, configuration information including a type of a drive, a capacity, a type of a RAID group, a configuration, and the like, a state (normal/closed) of each controller, and the like. The queue of the dirty data described above also belongs to the cache control information in the control information 200.

The journal protection method management table 200A is a table for managing the journal protection method described above.

The processing load management table 200B is a table that manages a threshold used when it is determined whether the processing load is equal to or more than a certain level.

When the control information and the cache data in the memory are updated at the time of one controller being closed, logs related to the contents are not necessarily written individually to a drive (memory backup drive) one by one, and may be written collectively in a continuous area on the drive (memory backup drive). However, for example, before a response of write completion is returned to the host, cache data and control information updated by the processing of the write are written to the drive (memory backup drive), and then data that has been written can be prevented from being lost due to a controller failure. The control information log buffer 502 and the cache data log buffer 503 are buffers for temporarily storing logs on the memory in this way, and the control information log and the cache data log are temporarily stored, respectively.

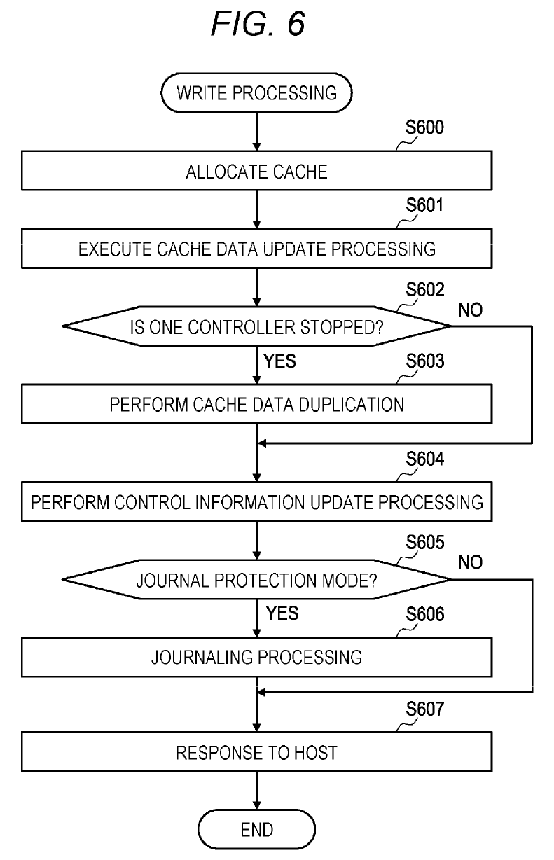

FIG. 6 is a flowchart illustrating an example of a procedure of the write processing in the storage system 100 according to the present embodiment. The CPU 106 executes the write processing.

The CPU 106 first performs cache allocation (step S600). The cache allocation refers to allocating a part of an area for storing cache data in the memory for I/O processing or the like. Here, in order to store data transmitted from the hosts 102A and 102B, an area having a sufficient size for storing the data is allocated.

The CPU 106 performs cache data update processing (step S601). Although the contents of the cache data update processing will be described later, in short, the cache data update processing is processing of receiving data from the hosts 102A and 102B and storing the data in a cache area allocated before.

The CPU 106 determines whether the other controller is closed (step S602). In a case where the controller is closed, the CPU 106 skips cache data duplication processing, and in a case where the controller is not closed, that is, in a case where both the controllers are in operation, the CPU 106 performs cache data duplication (step S603). The cache data duplication is processing of copying data received from the hosts 102A and 102B to a memory of the other controller. Specifically, the cache data duplication refers to copying data from the memory of the own controller to the memory of the other controller by using, for example, a DMA built in the CPU 106.

The CPU 106 performs control information update processing (step S604). Details of the control information update processing will be described later.

The CPU 106 determines whether the mode is a journal protection mode (step S605). The CPU 106 performs journaling processing in the case of the journal protection mode (step S606), and skips log saving processing in the case of not the journal protection mode. Since a general method can be adopted for the contents of the journaling itself, detailed description thereof will be omitted. The CPU 106 that has completed the above processing responds to the hosts 102A and 102B that the write processing has been completed (step S607). Here, the write processing ends.

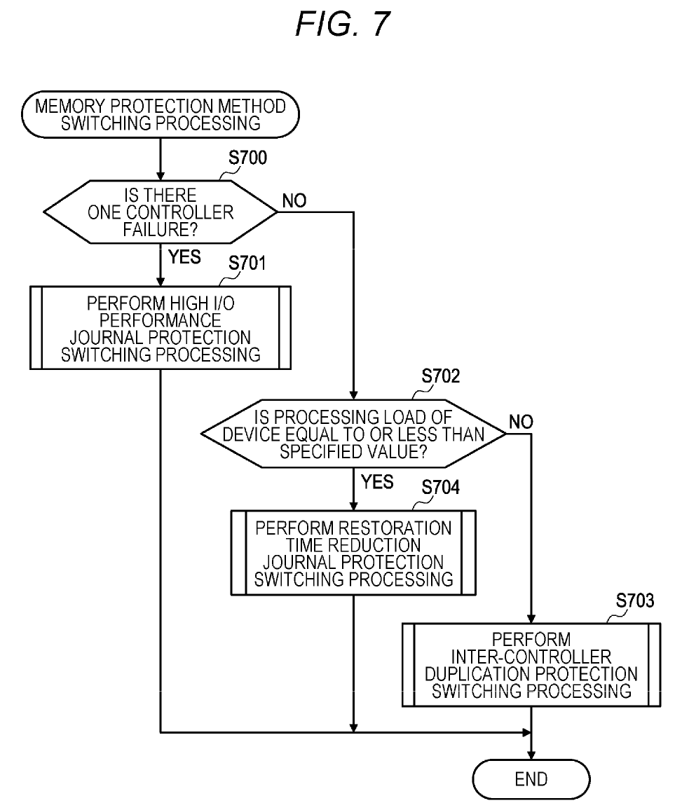

FIG. 7 is a flowchart illustrating an example of a procedure of memory protection method switching processing in the storage system 100 according to the present embodiment. The CPU 106 executes this memory protection method switching processing.

The CPU 106 determines whether a failure has occurred in one controller 103B. In a case where a failure occurs, the CPU 106 executes high I/O performance journal protection switching processing. Details of the high I/O performance journal protection switching processing will be described later.

On the other hand, in a case where no failure has occurred, the CPU 106 executes step S702. In step S702, the CPU 106 determines whether the processing load is equal to or less than a specified value. In a case where the processing load is equal to or less than a specified value in step S702, the CPU 106 executes restoration time reduction journal protection switching processing. Details of the restoration time reduction journal protection switching processing will be described later. On the other hand, in a case where the processing load is not equal to or less than the specified value in step S702, the CPU 106 executes inter-controller duplication protection switching processing. Details of the inter-controller duplication protection switching processing will be described later.

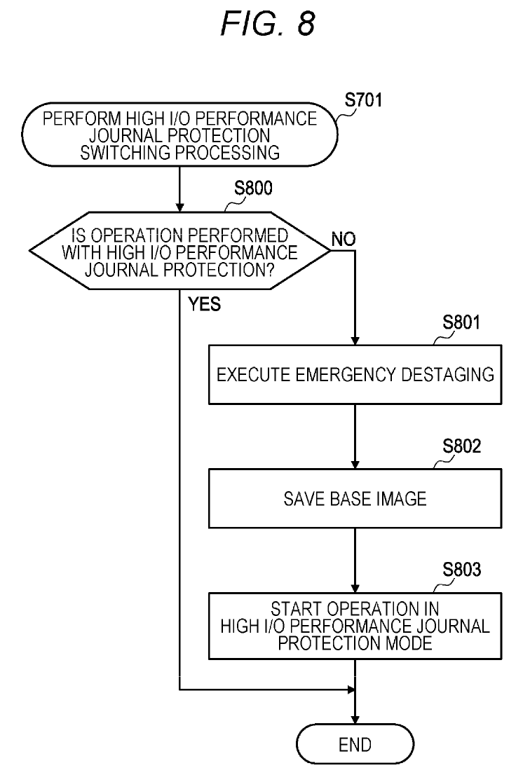

FIG. 8 is a flowchart illustrating an example of a procedure of the high I/O performance journal protection switching processing illustrated in FIG. 7. The CPU 106 executes the high I/O performance journal protection switching processing.

In step S800, the CPU 106 determines whether the operation is performed with the high I/O performance journal protection, and ends the high I/O performance journal protection switching processing when the operation is performed with the high I/O performance journal protection.

On the other hand, when the operation is not performed with the high I/O performance journal protection in step S800, the CPU 106 executes emergency destaging (step S801). Next, the CPU 106 saves a base image (step S802). In step S803, the CPU 106 starts operation in the high I/O performance journal protection mode.

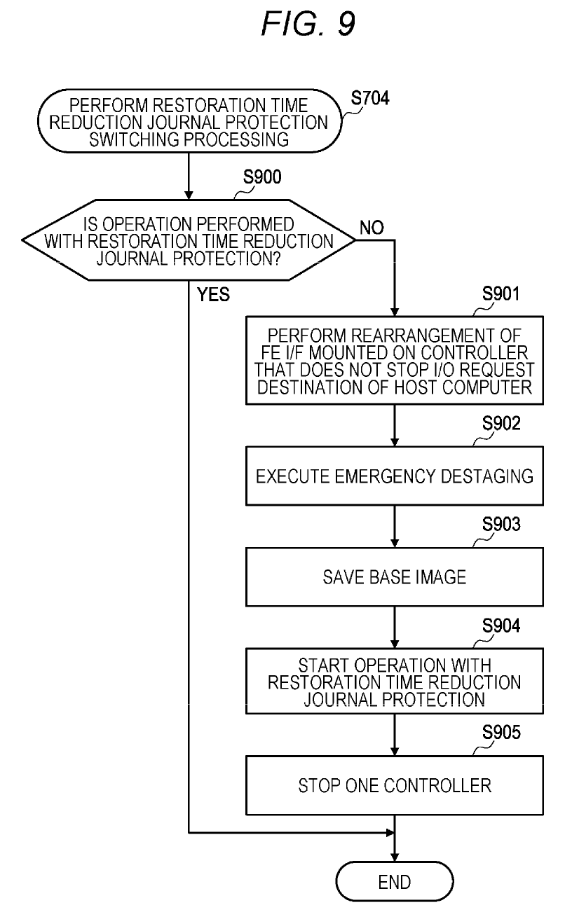

FIG. 9 is a flowchart illustrating an example of a procedure of the restoration time reduction journal protection switching processing illustrated in FIG. 7. The CPU 106 executes the restoration time reduction journal protection switching processing.

In step S900, the CPU 106 determines whether the operation is performed with the restoration time reduction journal protection, and ends the restoration time reduction journal protection switching processing when the operation is not performed with the restoration time reduction journal protection.

On the other hand, in a case where determining in step S900 that the operation is not performed with the restoration time reduction journal protection, the CPU 106 performs rearrangement to the FE I/F 104A mounted on the controller 103A that does not stop I/O request destination of the host computers 102A and 102B (step S901). At this time, a method of hiding by using a technology such as a virtual port function of FC may be combined so that the host computers 102A and 102B do not detect the stop of the controller 103B.

In step S902, the CPU 106 executes destaging in an emergency. In step S903, the CPU 106 saves the base image. In step S904, the CPU 106 starts the operation with the restoration time reduction journal protection. In step S905, the CPU 106 stops one controller 103B.

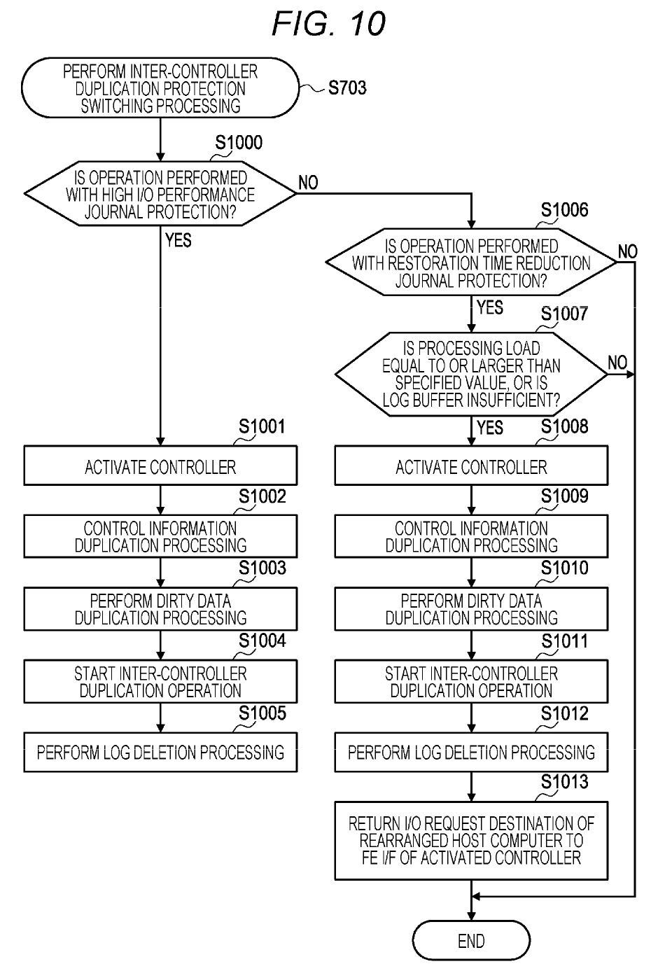

FIG. 10 is a flowchart illustrating an example of a procedure of the inter-controller duplication protection switching processing illustrated in FIG. 7. The CPU 106 executes the inter-controller duplication protection switching processing.

In step S1000, the CPU 106 determines whether the operation is performed with the high I/O performance journal protection. In a case where the operation is performed with the high I/O performance journal protection in step S1000, the CPU 106 executes step S1001.

In step S1001, the CPU 106 activates the controller 103B that has been stopped. In step S1002, the CPU 106 executes control information duplication processing. In step S1003, the CPU 106 executes dirty data duplication processing. In step S1004, the CPU 106 starts inter-controller duplication processing. In step S1005, log deletion processing is executed, and the inter-controller duplication protection switching processing ends.

On the other hand, in a case where the operation is not performed with the high I/O performance journal protection in step S1000, the CPU 106 executes step S1006. In step S1006, the CPU 106 determines whether the operation is performed with the restoration time reduction journal protection. In step S1006, in a case where the operation is not performed with the restoration time reduction journal protection, the CPU 106 ends the inter-controller duplication protection switching processing. On the other hand, in step S1006, when the operation is performed with the restoration time reduction journal protection, the CPU 106 executes step S1007.

In step S1007, the CPU 106 determines whether the processing load is equal to or larger than a specified value or whether the log buffer is insufficient. In step S1007, when the processing load is not equal to or larger than the specified value or the log buffer is not insufficient, the CPU 106 ends the inter-controller duplication protection switching processing. On the other hand, when the processing load is equal to or larger than the specified value or the log buffer is insufficient in step S1007, the CPU 106 executes step S1008.

In step S1008, the CPU 106 activates the controller 103B that has been stopped. In step S1009, the CPU 106 executes control duplication processing. In step S1010, the CPU 106 executes a dirty data duplication operation. In step S1011, the CPU 106 starts an inter-controller duplication operation.

In step S1012, the CPU 106 executes the log deletion processing. In step S1013, the CPU 106 returns the I/O request destination of the rearranged host computers 102A and 102B to the FE I/F 104B of the activated controller 103B.

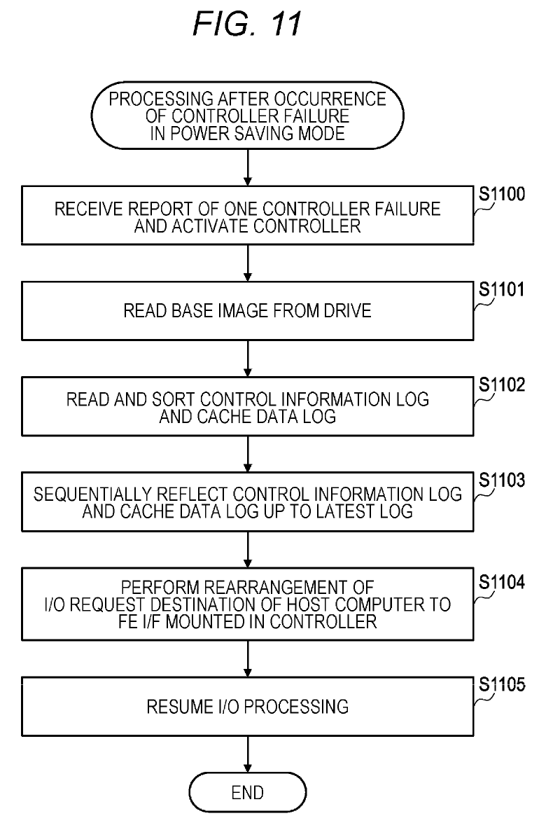

FIG. 11 is a flowchart illustrating an example of a procedure of processing after occurrence of a controller failure in the power saving mode. The CPU 106 executes the processing after occurrence of controller failure in the power saving mode.

In step S1100, the CPU 106 receives a report that a failure has occurred in one of the controllers, and activates the controller 103B that has been stopped. In step S1101, the CPU 106 reads the base image from the drive 110. In step S1102, the CPU 106 reads and sorts the control information log and the cache data log.

In step S1103, the CPU 106 sequentially reflects the control information log and the cache data log up to the latest log. In step S110, the CPU 106 performs rearrangement of the I/O request destination of the host computers 102A and 102B to the FE I/F 104A mounted on the controller 103B. In step S1105, the CPU 106 resumes the I/O processing, and ends the processing after occurrence of controller failure in the power saving mode.

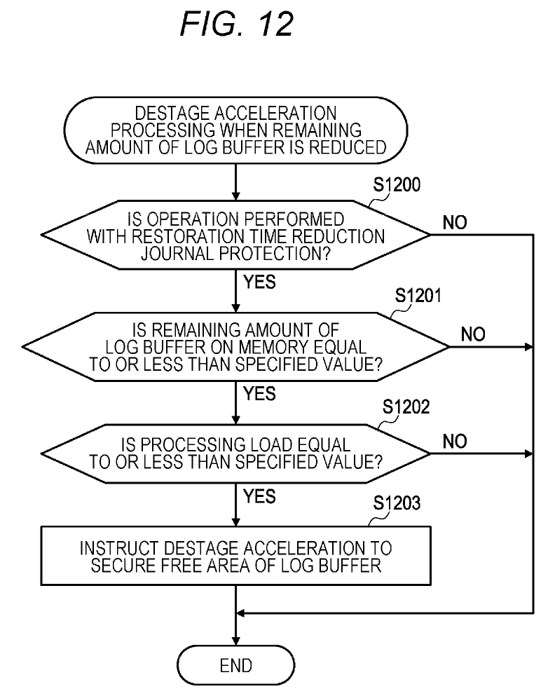

FIG. 12 is a flowchart illustrating an example of a procedure of destage acceleration processing when a remaining amount of the log buffer decreases. The CPU 106 executes the destage acceleration processing. The destage acceleration processing is processing of destaging the data 201 and the control information 200 as dirty data to the nonvolatile storage medium.

When the remaining amount of the log buffer is insufficient, the one controller 103A executes the destage acceleration processing of destaging the data and the control information as dirty data to the nonvolatile storage medium.

First, in step S1200, the CPU 106 determines whether the operation is performed with the restoration time reduction journal protection, and ends the destage acceleration processing in a case where the operation is not performed with the restoration time reduction journal protection.

On the other hand, in a case where determining in step S1200 that the operation is performed with the restoration time reduction journal protection, the CPU 106 executes step S1201. In step S1201, the CPU 106 determines whether the remaining amount of the log buffer is equal to or less than a specified value, and in a case where not determining that the remaining amount of the log buffer is equal to or less than the specified value, the CPU 106 ends the destage acceleration processing.

On the other hand, when determining in step S1201 that the remaining amount of the log buffer is equal to or less than the specified value, the CPU 106 executes step S1202. In step S1202, the CPU 106 determines whether the processing load is equal to or less than a specified value, and ends the destage acceleration processing when not determining that the processing load is equal to or less than the specified value.

On the other hand, when determining in step S1202 that the processing load is equal to or less than the specified value, the CPU 106 instructs destage acceleration so as to secure a free area of the log buffer. Here, the destage acceleration means performing destaging at a higher speed than a normal destaging.

The storage system 100 according to the present embodiment is a storage system including a plurality of controllers 103A and 103B that controls the data input/output processing between the host computers 102A and 102B and the drive 110, in which one controller 103A of the plurality of controllers 103A and 103B performs journaling in association with the data input/output processing and writes the journal data related to the data input/output processing between the host computers 102A and 102B and the drive 110 in the log buffer secured over the first range, when the processing load of another controller 103B of the plurality of controllers 103A and 103B satisfies the predetermined transition condition (for example, the processing load is equal to or less than a specified value) lower than in the normal state 1001, then the one controller starts the transition from the normal state to the power saving mode 1003 in which the another controller 103B is stopped (for example, closed or intentionally stopped), when the another controller 103B is stopped in the power saving mode 1003 that has been shifted, the one controller secures the log buffer to be in the second range narrower than the first range, and then performs journaling in association with data input/output processing between the host computers 102A and 102B and the drive 110, and when the another controller 103B is restarted, the one controller executes the restoration processing by using the journal data read from the log buffer secured over the second range.

In this way, when the processing load in the another controller 103B becomes lighter than the processing load in the normal state 1001, it is possible to reduce the power consumption amount by transitioning to the power saving mode thereafter. In the restoration processing, the log buffer from which the journal data is read is in the second range narrower than the first range, and the access time to the log buffer is shortened. For example, even in a case where one controller 103B of the plurality of controllers 103A and 103B is stopped to reduce the power consumption amount, it is possible to shorten the restoration time using the journal data. As a result, the controller 103A can resume duplexing of data input/output processing between the host computers 102A and 102B and the drive 110 at an earlier stage.

In the above embodiment, the one controller 103A then starts transition to the power saving mode 1003 for stopping the other controller 103B on the condition that the processing load of the other controller 103B is lower than in the normal state 1001 as the predetermined transition condition. In this way, even in a case where one controller 103B of the plurality of controllers 103A and 103B is stopped, the restoration time using the journal data can be shortened.

In the above embodiment, when a predetermined return condition different from the predetermined transition condition is satisfied, the one controller 103A transitions from the power saving mode 1003 to the normal state 1001. By setting the predetermined transition condition and the predetermined return condition to be different from each other in this way, it is possible to prevent frequent transition between the power saving mode 1003 and the normal state 1001.

In the above embodiment, the one controller 103A manages the log buffer by dividing the log buffer into a plurality of unit log buffers. In this way, it is easy to set the log buffer to the second range narrower than the first range for each unit buffer or to return the log buffer to the first range.

In the above embodiment, when the remaining amount of the log buffer is insufficient, the one controller 103A executes the destage acceleration processing of destaging the data 201 and the control information 200 as dirty data to the nonvolatile storage medium. In this way, the remaining amount of the log buffer is less likely to be insufficient, and the log buffer can be reliably set to the second range narrower than the first range or returned to the first range.

Note that this invention is not limited to the above embodiment, and includes various modifications and equivalent configurations within the spirit of the appended claims. For example, the above embodiment has been described in detail to facilitate understanding of the description of the invention, and the invention is not required to include all the configurations described above. Each element described in parallel in the present embodiment may have an aspect in which at least one of the elements is connected in series to another element.

This invention can be applied to a storage system related to a technology of storing journal data of a log buffer by journaling.

What is claimed is:

1. A storage system comprising a plurality of controllers that controls data input/output processing between a host computer and a drive, wherein
one controller of the plurality of controllers
performs journaling in association with the data input/output processing, and writes journal data related to the data input/output processing between the host computer and the drive to a log buffer secured over a first range,
when another controller of the plurality of controllers satisfies a predetermined transition condition, the one controller then starts transition from a normal state to a power saving mode for stopping the another controller,
when the another controller is stopped in the power saving mode after transition, the one controller secures the log buffer to be in a second range narrower than the first range, and then performs journaling in association with the data input/output processing between the host computer and the drive, and
when the another controller is restarted, the one controller executes restoration processing by using the journal data read from the log buffer secured over the second range.

2. The storage system according to claim 1, wherein
the one controller
then starts transition to the power saving mode for stopping the another controller on a condition that a processing load of the another controller is lower than in the normal state as a predetermined transition condition.

3. The storage system according to claim 1, wherein
when a predetermined return condition different from the predetermined transition condition is satisfied, the one controller transitions from the power saving mode to the normal state.

4. The storage system according to claim 1, wherein
the one controller
manages the log buffer by dividing the log buffer into a plurality of unit log buffers.

5. The storage system according to claim 1, wherein
when a remaining amount of the log buffer is insufficient, the one controller executes destage acceleration processing of destaging data and control information as dirty data to a nonvolatile storage medium.

6. A data protection method of a storage system including a plurality of controllers that controls data input/output processing between a host computer and a drive, the method comprising:
by one controller of the plurality of controllers,
performing journaling in association with the data input/output processing, and writing journal data related to the data input/output processing between the host computer and the drive to a log buffer secured over a first range,
when another controller of the plurality of controllers satisfies a predetermined transition condition, by the one controller, starting transition from a normal state to a power saving mode for stopping the another controller,
when the another controller is stopped in the power saving mode after transition, by the one controller, securing the log buffer to be in a second range narrower than the first range, and then performing journaling in association with the data input/output processing between the host computer and the drive, and
when the another controller is restarted, by the one controller, executing restoration processing by using the journal data read from the log buffer secured over the second range.
